(19) United States
(12) Patent Application Publication
(10) Pub. No.: US 2005/0091200 A1
(43) Pub. Date: Apr. 28, 2005

(54) System and method for taxonomy branch matching

(75) Inventors: Lucas R. Melton, Redmond, WA (US); Charles R. Reeves JR., Snohomish, WA (US); Luc Clement, Sammamish, WA (US); Eric Lee, Seattle, WA (US)

Correspondence Address: Law Offices of Albert S. Michalik, PLLC, Suite 193, 704-228th Avenue NE, Sammamish, WA, 98074, US

(73) Assignee: Microsoft Corporation, Redmond, WA (US)

(21) Appl. No.: 10/692,549

(22) Filed: Oct. 23, 2003

(51) Int. Cl. G06F 7/00

(52) U.S. Cl. 707/3

(57) ABSTRACT

A system and method for use with a taxonomy-based search service that locates expanded information based on a query the client has proposed, by performing an automatically expanded branching of the query. The client specifies a starting point (corresponding to an origin node) in the taxonomy along with one or more genealogical directions to expand the search, such as to parent, children and/or sibling nodes. Variables may specify how many generations upward and/or downward should be included in the expanded search. A middle tier receives the request and converts it to the relevant queries needed to query a database that maintains the taxonomy, such that the client receives a result set that contains expanded results without needing any contextual knowledge of the taxonomy. The middle tier may be implemented, for example, in a UDDI-based environment that helps clients locate web services and other information.

### FIELD OF THE INVENTION

The invention relates generally to computer systems and networks, and more particularly to locating information.

### BACKGROUND OF THE INVENTION

There are many types of computing resources (e.g., services, devices, data and so forth) that computer client users and client applications (or simply clients) need to manage and otherwise access, such as services and data maintained on corporate networks and other remotely accessible sites, including intranets and the internet. As there are many different computing platforms, various platform-independent mechanisms and protocols that facilitate the exchange of network information are becoming commonplace, including HTTP (HyperText Transfer Protocol), XML (extensible Markup Language), XML Schema, and SOAP (Simple Object Access Protocol). The concept of Web services, in which businesses, organizations, and other providers offer services to clients, is based on these standards. Web services are services that connect applications across an intranet, extranet, or across the Internet, so that these applications can share resources and information. Web services can be offered by any individual or organization that has the tools to create them and make them available to other individuals or organizations online.

To be of value, web services need to enable such clients to locate them, and exchange the information needed to execute them. To this end, UDDI (Universal Description Discovery & Integration) provides a set of defined services (e.g., in a UDDI Business Registry) that help clients discover such businesses, organizations, and other Web services providers, along with a description of their available web services and the technical interfaces needed to access those services. UDDI thus facilitates the connection between the providers and the consumers of Web services. Although such services may be provided over the internet, services also may be provided in an enterprise environment or other intranet, where the services and their usage may be more controlled. Thus, not just UDDI, but other service registries (such as one based on Microsoft Corporation's Active Directory®) may provide a way of locating a distributed service or other information.

Regardless of the service registry and the type of information and/or service being sought, taxonomies such as those available as categorization schemes within UDDI may be used to group sets of related values for use typically to categorize entities such as Web services or Web service providers. These values make up the “nodes” of a taxonomy. The nodes typically offer a hierarchical breakdown of a domain (such as the series of hierarchically arranged nodes in a geographic taxonomy path “World/Europe/UK/Scotland”). Taxonomies may also cover domains where there is no established hierarchy, such as by placing all nodes as peers at the top, or root level.

Using taxonomy-related services such as UDDI Services, clients are able to query for entities or other data that are categorized by a value in a given taxonomy. However, because the client is only able to query by value, the client needs to have a certain level of a-priori knowledge of the taxonomy to widen the scope of the search when needed. For example, consider a taxonomy that categorizes the states in the United States of America. A client can query for entities that are categorized with the value ‘California’, but in order to query for nearby entities, the client would have to know that ‘Nevada’ and ‘Oregon’ are nearby states so that these values could be used in further queries as desired. The service that categorized the entities with such a taxonomy likely would know this information, but the client querying the service often will not.

As a result, a client is required to know something about the taxonomy, otherwise the client is unable to widen the search scope to locate possibly valuable information. While this may appear simple with well-known entities such as states, in actuality there are many kinds of taxonomies having various kinds of data, and many varieties of clients. Requiring clients to have pre-existing knowledge of these many, possibly diverse taxonomies is an unreasonable requirement, and in general is a deficiency of taxonomy searching technologies. Consequently, finding relevant categorized results can be difficult. What is needed is a better way for clients that do not have prior knowledge of a taxonomy's structure to locate related data within that taxonomy.

### SUMMARY OF THE INVENTION

Briefly, the present invention provides a system and method for use with a taxonomy-based search service that locates expanded information based on a query the client has proposed, by performing an automatically expanded branching of the query based on the genealogical branch specified by the client. The system and method thereby provide wider and valuable search results while isolating the user from the contextual knowledge of a given taxonomy.

In general, the taxonomy branch matching technology of the present invention allows the client to specify a starting point in the taxonomy, referred to as an origin node, along with data specifying one or more genealogical directions to expand the search. Thereafter the client automatically receives a result set that contains expanded results from nodes in the taxonomy that are related to the origin node, (as well as possibly including any relevant data corresponding to the origin node).

Genealogical directions for which a search may be automatically expanded in a taxonomy include ancestors (higher parent nodes) of a specified origin node, descendants (lower children nodes) of the origin node, and/or sibling nodes of the origin node. A family search may be specified that expands the search to return ancestors, descendants and siblings. When specifying ancestors (or family) as an expansion direction, a variable may be used to specify how many generations of parents the upward branch should be included in the expanded search. Similarly, when specifying descendants (or family) as an expansion direction, another variable may be used to specify how many generations of children downward should be included in the expanded search.

In general, the present invention may be implemented in a middle tier between a client and a taxonomy service that returns search results from a database. Note that the middle tier may be incorporated into the service. The middle tier recognizes requests for an expanded search, and invokes expansion logic to expand the search in the requested direction or directions relative to the origin node, by converting the expansion request into requests that the service understands, e.g., UDDI find requests in a UDDI environment.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a representation of a general taxonomy;

FIG. 3 is a representation of an example geographic-based taxonomy;

FIG. 4 is a block diagram generally representing the flow of information to provide expanded results, in accordance with an aspect of the present invention; and

FIG. 5 is a block diagram generally representing a client request for expanded results with respect to a node of a taxonomy, and a server response, in accordance with an aspect of the present invention.

### DETAILED DESCRIPTION

Exemplary Operating Environment

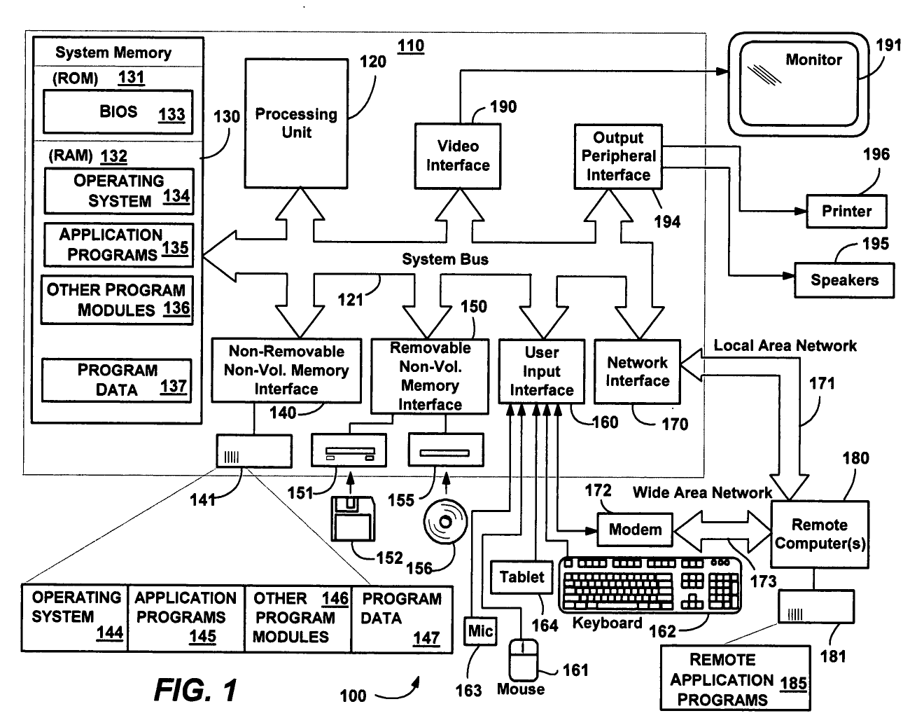

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Taxonomy Branch Matching

The present invention is in part, generally directed towards distributed network resources (e.g., services and devices), in which a client running on essentially any platform may use a defined protocol such as SOAP (Simple Object Access Protocol) to access network resources over UDDI. However, the present invention is not limited to UDDI, but applies to any technology that handles requests related to value set information that may be arranged as nodes in a taxonomy. Thus, while the present invention will primarily be described with reference to UDDI and UDDI services, it is understood that the present invention may apply to locating related information in general. Further, while the present invention will be primarily described with respect to SOAP, XML, UDDI, and/or Windows®/.NET, it is understood that the present invention is not limited to any particular implementation, protocols, components, APIs, and so forth, but also encompasses similar mechanisms for interacting over a network. Thus, although the examples herein are related to the UDDI standards, it is understood that the actual invention may be abstracted to provide generic capabilities for performing searches based on hierarchical categorizations on alternate systems.

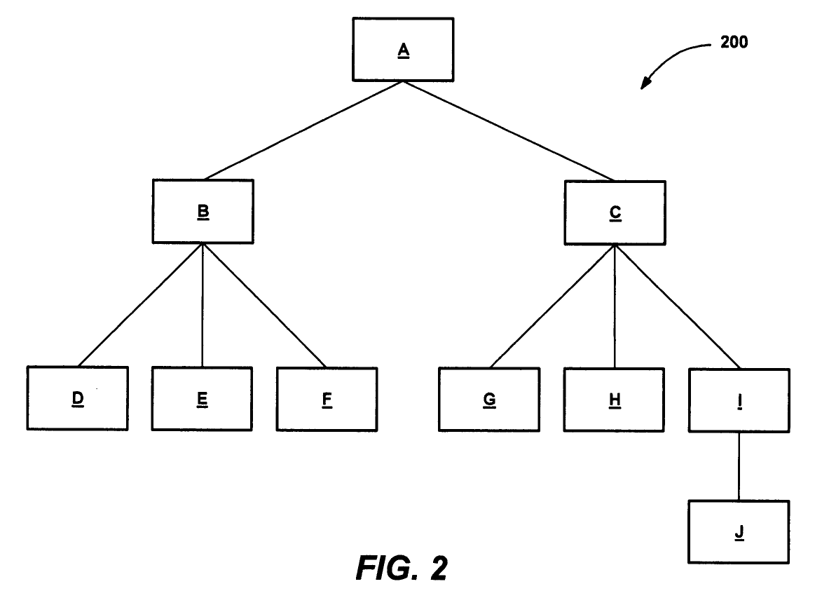

As generally represented in FIG. 2, taxonomies provide sets of related values, which may be used to categorize entities such as web services or Web service providers, devices and other resources such as data. These values make up the nodes within a taxonomy, particularly one of a number of categorization scheme and identifier-based taxonomies. The nodes typically offer a hierarchical breakdown of a domain, although taxonomies may also cover domains where there is no established hierarchy, e.g., by placing multiple nodes as peers at the top or “root” level. FIG. 2 illustrates one example taxonomy 200, which may be directed to virtually any related domain classification. Note that one or more other root nodes are also possible within a taxonomy.

In FIG. 2, a root node A has child nodes B and C which in turn have child nodes D-I, until some leaf node is reached in each branch. In this case, nodes D-H and node J are the leaf nodes. Any node may be specified in a search, e.g., in a geographical-based taxonomy, a city may be specified that corresponds to a “city” node.

In general, a search begins relative to a starting point (node) in the taxonomy referred to as an origin, identified by a starting keyed reference. In FIG. 2, consider the node ‘B’ as the starting keyed reference, or origin node, in the taxonomy 200; for a query that essentially stated “given a keyed reference of ‘B’ return its parent,” the result set would contain ‘A’. Note that each query represents one round trip to a database containing the taxonomy to get results, wherein as used herein, the term “database” may denote the storage that maintains the data, in any suitable structure, or the program that accesses the storage, (or both) as appropriate. Alternatively, a query such as “given a starting keyed reference of ‘B’ return its siblings” would return a result set containing ‘C’ because there is only one sibling (having the same parent) of the ‘B’ node. Again, this query represents one round trip to the database. A query such as “given a keyed reference of ‘B’ return its children,” would return ‘D’ ‘E’ and ‘F’ in the result set, again built from one database query/roundtrip.

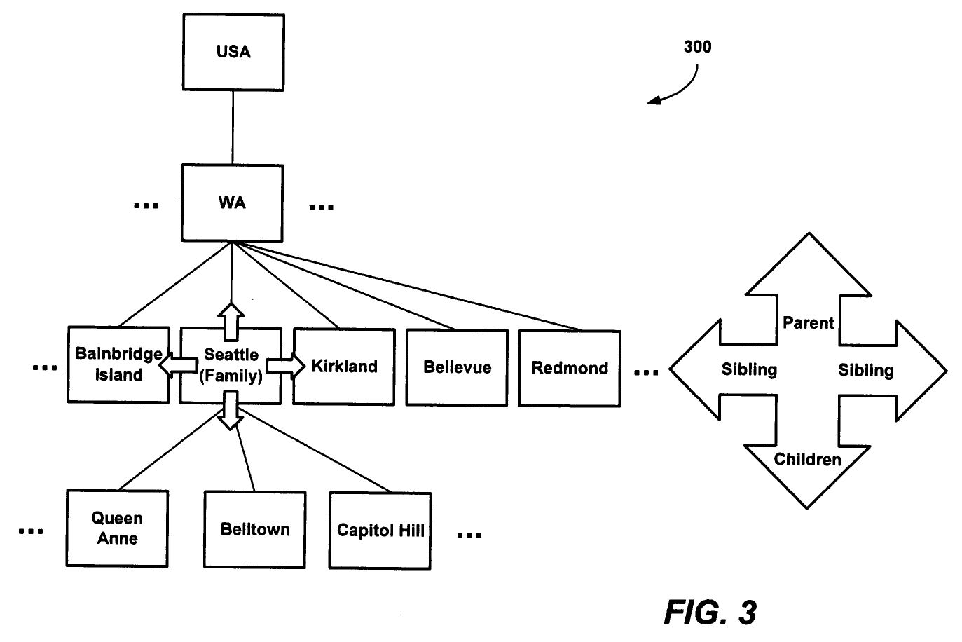

FIG. 3 is an example of a geographic-based taxonomy 300, such as directed to a map. As represented in FIG. 3, as is normal within a hierarchically-arranged taxonomy, each child node represents a narrower classification with respect to its parent node. The example shows a country node (USA), state nodes as children of the country node, city nodes as children of the state nodes, and neighborhood/district nodes as children of the city nodes. Although in FIG. 3 the country node is shown as what appears to be a root node, it is understood that higher parent nodes are possible, e.g., a “continent” node may be a parent of the country node, a “world” node a parent of the “continent” node, and so on as appropriate for a given taxonomy.

In accordance with an aspect of the present invention, the present invention facilitates a way to expand a query to include data corresponding to one or more nodes having genealogical relationships (ancestors, descendants and/or siblings) relative to an origin node. Thus, a client that knows a value to provide in a query is able to receive a result set that can return expanded data that is genealogically close along the branch specified to that specifically requested value. For example, a client seeking a business in a particular area might know one nearby city, but does not want the search limited only to that city. Similarly, having knowledge of a nearby street will not find a location that is nearby but not exactly on that street, unless the search is expanded beyond that exact value. For practical reasons, most taxonomies cannot include such expanded data within each node that may be specified. Instead, the present invention expands queries, so as to obtain results that are not limited to a specified node in a taxonomy, but rather by locating related nodes on one or more appropriate branch or branches in that taxonomy.

To this end, the method and system of the present invention provide a feature, such as implemented in a middle tier between the client and a server that provides the taxonomy access, which allows the user to express expanded (branched out) requests. In general, and as described below, the middle tier includes expansion logic that can convert a request having certain information, e.g., within UDDI keyedReferences and keyedReferenceGroups, into a set of requests that the taxonomy service can understand. Note that it is alternatively feasible to extend existing schemas, however using keyedReferences and keyedReferenceGroups enables support of clients from multiple platforms.

The following is an XML-based example of how this feature may be expressed in an example UDDI find message:

<find_business xmlns=“urn:uddi-org:api_v3”>

<findQualifiers>

<findQualifier>uddi:uddi.org:findQualifier.orAllKeys</findQualifier>

</findQualifiers>
<categoryBag>
<keyedReference keyValue=“85.14.15.01.00” tModelKey=“uddi:org:categorization:unspsc”/>
<keyedReferenceGroup tModelKey = “microsoft:uddi.genealogicalExpansion”>

| | |
|---|---|
| <keyedReference | keyValue = “Seattle” |
| | tModelKey = “microsoft:mapPoint:origin”/> |
| <keyedReference | keyValue = “family” |
| | tModelKey = “microsoft:uddi.genealogicalExpansion:expansionDirection”/> |
| <keyedReference | keyValu = “1” |
| | tModelKey = “microsoft:uddi.genealogicalExpansion:maxDescendents ”/> |

<keyedReference keyValue = “2”

tModelKey = “microsoft:uddi.g nealogicalExpansion:maxAncestors ”/>

</keyedReferenceGroup>

</categoryBag>

</find_business>

In UDDI-based environment, this feature will be modeled as a tModel, wherein the tModel key used is ‘microsoft:uddi.genealogicalExpansion’ in this example implementation.

To recognize a request seeking expanded data in this example implementation, the presence of a keyedReferenceGroup that specifies this ‘genealogicalExpansion’ tModel key is detected at the middle tier, and in essence, tells the middle tier that this particular keyedReferenceGroup should be processed as a request for expanded data. Other ways of determining that a search should be expanded are feasible, such as scanning the request for any tModel key related to genealogical expansion (e.g., in the example request above, three keyed references are present that each specify expansion criteria via their tModel keys, and one or more these may be detected). Requests without this information may be passed to the service directly, or otherwise processed at the middle tier, e.g., to provide other non-conventional request handling services. Note that in an alternative implementation, expanded searches may be the default operation, e.g., expanded searching will occur unless an indicator or the like is used to turn off expanded searching to get an exact search.

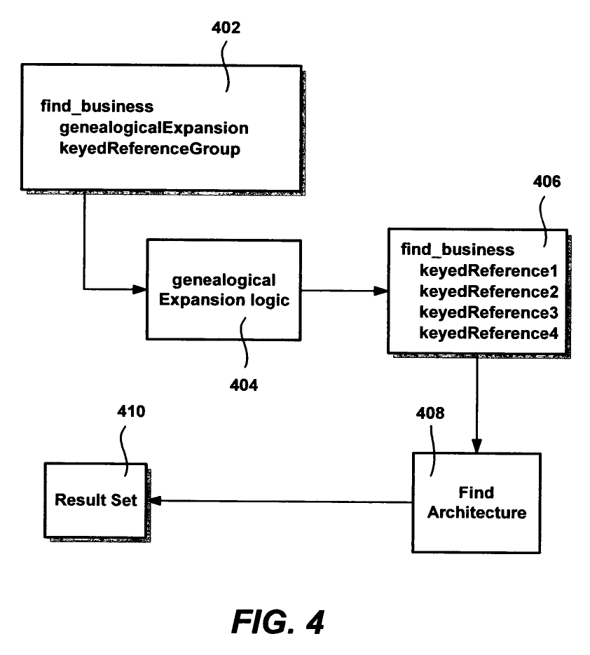

FIG. 4 shows a general conceptual flow of data in one implementation, in which a request 402 containing the KeyedReferenceGroup that specifies the genealogicalExpansion tModel key is processed by genealogical expansion logic 404 (e.g., in the middle tier) into a set of conventional “Find” business requests 406. For example, SQL stored procedures or ad hoc queries may be built to provide a set of individual queries that the taxonomy service can handle, such as a set of conventional UDDI “Find” requests, which are handled by Find architecture 408 in a known manner to return a result set 410. In a SQL environment, the IN Clause can obtain such information relative to the origin.

The following XML element is what identifies this message as requiring genealogical expansion:

<keyedReferenceGroup tModelKey =
“microsoft:uddi.genealogicalExpansion”>
<find_business xmlns=“urn:uddi-org:api_v3”>

<findQualifiers>

<findQualifier>uddi:uddi.org:findQualifier:orAllKeys</findQualifier>

</findQualifiers>
<categoryBag>
<keyedReference keyValue=“85.14.15.01.00”

tModelKey=“uddi:org:categorization:unspsc”/>

<keyedReferenceGroup tModelKey =

“microsoft:uddi.genealogicalExpansion”>

<keyedReference keyValue = “Seattle”

tModelKey = “microsoft:mapPoint:origin”/>

<keyedReference keyValue = “family”

tModelKey =

“microsoft:uddi.genealogicalExpansion:expansionDirection”/>

<keyedReference keyValue = “1”

tModelKey =

“microsoft:uddi.genealogicalExpansion:maxDescendents ”/>

| | |
|---|---|
| <keyedReference | keyValue = “2” |
| | tModelKey = |

“microsoft:uddi.genealogicalExpansion:maxAncestors ”/>

</keyedReferenceGroup>

</categoryBag>

</find_business>

In the above example, the presence of the “microsoft:uddi.genealogicalExpansion” key on the keyedReferenceGroup element identifies this UDDI find message as one that requires genealogical expansion. This message still adheres to the UDDI specification, so if an implementation did not support genealogical expansion it could still process this UDDI find message; abeit with different results.

In this example, the genealogical expansion will be done for 1 level of descendants and 2 levels of ancestors, starting from the origin specified as ‘Seattle’.

| | |
|---|---|
| <keyedReference | keyValue = “family” |
| | tModelKey = |

“microsoft:uddi.genealogicalExpansion:expansionDirection”/>

is translated into a search that could be implemented in SQL as follows:

SELECT BT.ID
FROM Businesses BT
WHERE BT.ID IN (SELECT BC.BusinessID FROM BusinessCategories
BC
WHERE BC.ParentValue = “Seattle”)

The results of this SQL would be returned as keyedReferences; suppose that the following results are returned.

| | |
|---|---|
| <keyedReference | keyValue = “Capitol Hill” |

tModelKey = “microsoft:mapPoint:origin”/>

| | |
|---|---|
| <keyedReference | keyValue = “Queen Anne” |

tModelKey = “microsoft:mapPoint:origin”/>

| | |
|---|---|
| <keyedReference | keyValue = “Belltown” |
| | tModelKey = “microsoft:mapPoint:origin”/> |

| | |
|---|---|
| <keyedReference | keyValue = “2” |
| | tModelKey = |

“microsoft:uddi.genealogicalExpansion:maxAncestors ”/>

is translated into a search that could be implemented in SQL as follows:

DECLARE originParent = SELECT ParentValue

FROM BusinessCategories BC
WHERE BC.Value = “Seattle”

DECLARE parent = SELECT ParentValue

FROM BusinessCategories BC
WHERE BC.Value = originParent;

SELECT BT.ID
FROM Businesses BT
WHERE BT.ID IN (SELECT BC.BusinessID

FROM BusinessCategories BC
WHERE BC.ParentValue = parent)

This SQL is actually run recursively, depending on the number of levels specified; in this example, the SQL would recurse two times in order to obtain two levels of ancestors.

The results of this SQL would be returned as keyedReferences; suppose that the following results are returned:

| | |
|---|---|
| <keyedReference | keyValue = “King County” |
| | tModelKey = “microsoft:mapPoint:origin”/> |
| <keyedReference | keyValue = “WA” |
| | tModelKey = “microsoft:mapPoint:origin”/> |

The results of the descendant and ascendant searches replace the genealogical keyedReference group. Thus, the find message after genealogical expansion looks as follows:

<keyedReferenceGroup tModelKey =
“microsoft:uddi.genealogicalExpansion”>
<find_business xmlns=“urn:uddi-org:api_v3”>

<findQualifiers>

<findQualifier>uddi:uddi.org:findQualifier:orAllKeys</findQualifier>

| </findQualifiers> | |
|---|---|
| <categoryBag> | |
| <keyedReference | keyValue=“85.14.15.01.00” |

tModelKey=“uddi:org:categorization:unspsc”/>

| | |
|---|---|
| <keyedReference | keyValue = “Seattle” |
| | tModelKey = “microsoft:mapPoint:origin”/> |
| <keyedReference | keyValue = “Capitol Hill” |

tModelKey = “microsoft:mapPoint:origin”/>

| | |
|---|---|
| <keyedReference | keyValue = “Queen Anne” |

tModelKey = “microsoft:mapPoint:origin”/>

| | |
|---|---|
| <keyedReference | keyValue = “Belltown” |
| | tModelKey = “microsoft:mapPoint:origin”/> |
| <keyedReference | keyValue = “King County” |
| | tModelKey = “microsoft:mapPoint:origin”/> |
| <keyedReference | keyValue = “WA” |
| | tModelKey = “microsoft:mapPoint:origin”/> |

</categoryBag>

</find_business>

This find message is now a ‘regular’ UDDI find message and can be processed as any other UDDI find message. This example implementation allows a UDDI implementation to be retro fitted with genealogical expansion with a minimal amount of effort.

Thus, once the expansion logic 404 receives the keyedReferenceGroup, the keyedReferenceGroup is converted to the set of keyedReferences and provided to the service as a message. From the perspective of the service, this resulting message will look as though the client had individually specified the keyed references for each related node in an appropriate expansion direction, whereby the message can be processed like any other find message. Note that this feature leverages the current find infrastructure by expanding the keyed references into regular find message. This allows the middle tier to reuse other aspects of the infrastructure, including current querying and sorting implementations. In other words, this type of search is not treated any differently from a regular find request from the perspective of the service.

Returning to the example XML request, the next set of XML specifies the keyedReference at which the expansion is to start, that is, the origin parameter is modeled as a tModel:

<keyedReference keyValue = “Seattle”

tModelKey = “microsoft:mapPoint:origin “/>

This feature requires that this keyedReference be present within the keyedReferenceGroup.

The following comprises example code that instructs the expansion logic on how (i.e., what direction or directions to follow) to expand the query:

| | |
|---|---|
| <keyedReference | keyValue = “family” |
| | tModelKey = |

“microsoft:uddi.genealogicalExpansion:expansionDirection”/>

Valid values for keyvalue parameters corresponding to an expansion direction include family as shown above, parent (e.g., <keyedReference keyvalue=“parent” . . . />), children (e.g., <keyedReference keyvalue=“children” . . . />, and siblings, e.g., <keyedReference keyvalue=“siblings” . . . />. As is understood, other terms are equivalent (e.g., ancestors, descendants, up, down, sideways and so forth could be used). Specifying “Family” returns ancestors, descendants and siblings. Note that other genealogical relationships are possible, such as compound relationships (e.g., expand the search up to a parent and all the parent's siblings).

As represented in the above XML example, when expanding a search to branch upward in the hierarchy, e.g., by specifying parent or family, a maxAncestors value may be specified that indicates how far upward to expand the search, e.g., a maximum parameter value of one requests the immediate parent, a value of two requests the immediate parent and its parent (the grandparent), and so on. Similarly, for downward branch expansion, e.g., by specifying children or family, a maxDescendents value may be specified, e.g., in which a maximum parameter value of one requests the immediate children, two requests the children and grandchildren, and so on.

Continuing with the XML example, the following thus allows the user to determine how many generations (one in this example) of descendants to expand:

| | |
|---|---|
| <keyedReference keyValue = | “1” |
| tModelKey = | |

“microsoft:uddi.genealogicalExpansion:maxDescendents “/>

Note that an entire generation is retrieved in one query/round trip. As can be appreciated, the maximum descendants value is only relevant if the expansion direction is family or children. If this value is not specified, a default setting is used, which may be client-configurable. Further, this value could be constrained by a client-specified value, e.g., not greater than three.

As is understood, ancestors (parents) are similarly handled:

| | |
|---|---|
| <keyedReference keyValue = | “2” |

tModelKey =

“microsoft:uddi.genealogicalExpansion:maxAncestors “/>

This optional keyedReference allows the client to determine how many generations of ancestors (two in this example) to expand. An entire generation is retrieved in one query/round trip, and the value is only relevant if the expansionDirection is family or parent. If this value is not specified, a default setting is used, which may be client configurable. Also, this value could be constrained by a client specified value.

Note that in one implementation, the number of siblings cannot be specified. Thus, in this implementation, if family or sibling is specified for expansionDirection, then all of the direct siblings of the origin keyed reference are returned. Note however that in alternative implementations it is feasible to place a limit on the number of siblings returned, although the sibling selection mechanism may be as simple as cutting off the result set at whatever point the limit is reached.

By way of example of an expanded search, returning to FIG. 3, specifying “Seattle” as the origin node and parent (or family) with a maxAncestors value of two returns data from the “WA” node, which is the parent state, and the “USA” node, which is the country node, the parent of the state node (i.e., the grandparent of the origin node). The “Seattle” node may also be accessed to return data in the result set.

Specifying “Seattle” as the origin and child (or family) with a maxDescendants value of one returns the neighborhood/districts nodes' data, including those shown in FIG. 3 (Belltown, Queen Anne and Capitol Hill) along with any others. Specifying “Seattle” as the origin and “siblings” returns other Washington cities, including those shown in FIG. 3 (Bainbridge Island, Kirkland, Bellevue and Redmond) along with any others.

As described above, specifying “family” as in the example XML code returns parents up to the maximum ancestors value, children up to the maximum descendants value and siblings.

In this manner, a straightforward request such as formatted in XML may be used to return an expanded result set. As can be readily appreciated, instead of relying on the client to have intimate knowledge of the taxonomy structure (which would be impractical), or having each node contain the data of its family (which would defeat the purpose of a structured taxonomy), the information specified in the request expands the result set as desired.

Note that in an alternative implementation, rather than modeling parameters as a tModel, a keyName can be used for the parameter value. For example, when specifying the origin, the following alternative structure may be implemented:

| | | |
|---|---|---|
| <keyedReference | keyName | = “origin” |
| | keyValue | = “REDMOND” |
| | tModelKey | = “microsoft:mapPoint”/> |

This may be somewhat less advantageous, because a keyName expression is required to specify the parameter name. However, this alternative modeling approach is semantically identical, and would not result in significant implementation differences.

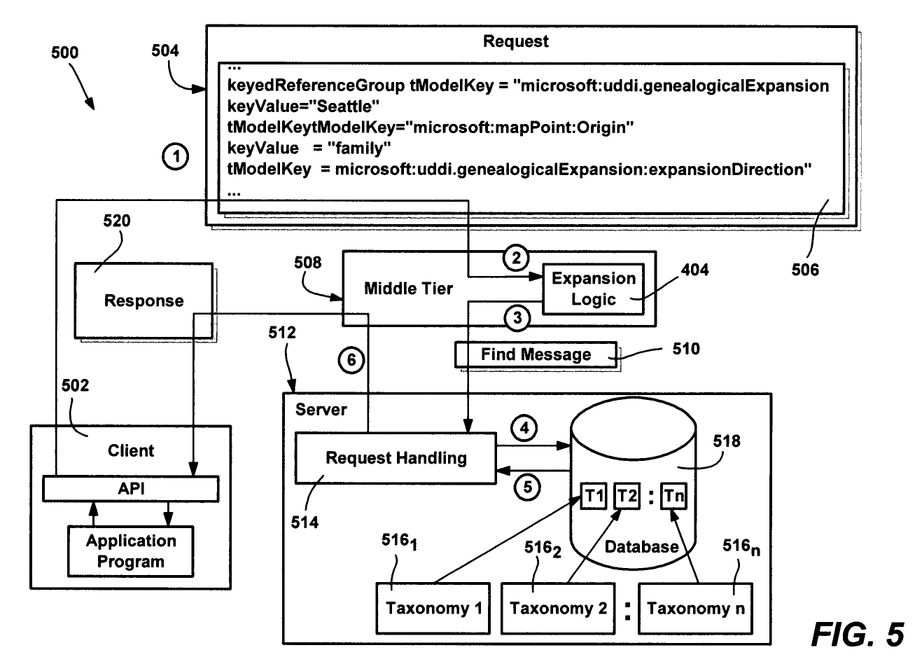

Turning to an explanation of the operation of the present invention, the general request operation is represented in FIG. 5 by the arrow labeled one (1), where the client 502 (e.g., an application program associated therewith calling an application programming interface, or API which, for example may format the request into an XML message) provides a request 504 including the expanded search indicator, (e.g., keyedReferenceGroup tModelKey=“microsoft:uddi.genealogicalExpansion). As described above, the keyedReferenceGroup indicator indicates to the middle tier 508 that this request needs the expansion logic 404 to convert the group request into a find message 510 having find requests appropriate for the service, e.g., individual find requests, as generally represented in FIG. 5 by the arrows labeled two (2) and three (3). The request 504 also provides the middle tier 508 with a parameter for expanding the search in at least one a branch direction, and may include one or more parameters indicating how far to expand in corresponding directions.

A request handling mechanism 510 of the taxonomy service's server 512 attempts to locate the appropriate taxonomy, e.g., 516, in an appropriate database 518 (comprising any suitable data structure). If located, the request handling mechanism 514 queries the database 518 for each find request, as generally represented in FIG. 5 by the arrows labeled four (4) and five (5). A response 520 is assembled from the individual requests, including the result set expanded in accordance with the present invention and returned to the requesting client 502, as generally represented in FIG. 5 by the arrows labeled six (6). Note that if the server is capable of handling multiple find requests in the same message, the server constructs the result set which is then passed to the client. Otherwise the middle tier assembles the separate result from each find request into the response 520. The response may include an indication of on which branch each match was found, e.g., result X was found two generations above the origin, result Y was found as a sibling of the origin, and so on.

As can be readily appreciated, the middle tier 508 is shown as separate from the server 512 in FIG. 5, however the server 512 can incorporate the logic of the middle tier 508, including the expansion logic 404. Indeed, the client can alternatively include such logic, such as in an operating system component shared by applications. Thus, as used herein, the term middle tier, expansion logic and so forth, and indeed any of the components described herein may be located essentially anywhere in the computing environment, and further, may be combined into a lesser number of code portions, and/or further separated into a greater number of code portions.

Note that the present invention may be combined with other taxonomy-based mechanisms. For example, U.S. patent application Ser. No. 10/607,812 entitled “System and Method for Enabling Client Applications to Interactively Obtain and Present Taxonomy Information,” (assigned to the assignee of the present invention and hereby incorporated by reference) describes a system and method in which client applications may interactively obtain taxonomy information from a UDDI server and thereby present that information to a user, such as to enable navigation through the taxonomy. An application programming interface is provided by which a client application sends a unique taxonomy identifier and a relationship qualifier (e.g., root, parent and/or child) to a server. The client may also identify a reference node within the taxonomy. The server receives the (e.g., XML) request message, and extracts the data to query a database based on the relationship qualifier (or qualifiers) and the taxonomy/reference node. Based on the query results, the server returns a response that provides relationship information to the client, such as information on root, parent and/or child nodes that satisfy the request. The client interprets the response to present the taxonomy, such as for user navigation through the taxonomy.

As can be readily appreciated, when such navigation is combined with the present invention, the client may, for example, navigate to a node and select that node as the origin node from which a branching search in accordance with an aspect of the present invention is desired. Alternatively, a client could receive expanded results from a node via branch matching and use the navigation mechanism to see the relationship between the nodes.

As can be seen from the foregoing detailed description, there is provided a method and system by which clients can obtain expanded results from a taxonomy (e.g., any categorizations and identifier based taxonomies) based on data obtained from nodes having a genealogical relationship with an origin node. The method and system thus expand searches to specified directions (branches) in a taxonomy, in a manner that is straightforward for clients to use and is flexible, thereby providing access to relevant information without prior knowledge of the taxonomy structure, and without requiring modification of the way in which existing find handling mechanisms operate. The method and system thus provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. In a computing environment, a method comprising:
receiving a request for taxonomy-related information, the request including data corresponding to an origin node within a taxonomy and data indicating that an expanded result set is desired;
providing at least one query for taxonomy-related data corresponding to at least one node that is genealogically related to the origin node;
receiving taxonomy-related data based on the at least one query; and
returning a result set that includes the taxonomy-related data in response to the request.

2. The method of claim 1 further comprising, interpreting the request to determine that the request seeks data from at least one ancestor node of the origin node.

3. The method of claim 2 wherein an ancestor node corresponds to a direct parent node of the origin node.

4. The method of claim 2 wherein the request includes a value corresponding to one or more generations of ancestor nodes from which data is being sought.

5. The method of claim 1 further comprising, interpreting the request to determine that the request seeks data from at least one descendant node of the origin node.

6. The method of claim 6 wherein a descendant node corresponds to at least one immediate child node of the origin node.

7. The method of claim 5 wherein the request includes a value corresponding to one or more generations of descendant nodes from which data is being sought.

8. The method of claim 1 further comprising, interpreting the request to determine that the request seeks data from at least one sibling node of the origin node.

9. The method of claim 1 further comprising, interpreting the request to determine that the request seeks data from at least one ancestor node relative to the origin node, at least one descendant node relative to the origin node, and at least one sibling node relative to the origin node.

10. The method of claim 9 wherein the request includes a value corresponding to one or more generations of ancestor nodes from which data is being sought.

11. The method of claim 9 wherein the request includes a value corresponding to one or more generations of descendant nodes from which data is being sought.

12. The method of claim 1 wherein the request comprises an XML message, and wherein returning a result set that includes the taxonomy-related data further comprises formatting the response as an XML message.

13. The method of claim 1 wherein the taxonomy-related information corresponds to a taxonomy maintained at a UDDI server.

14. The method of claim 1 wherein the taxonomy-related information corresponds to a taxonomy having device information maintained therein.

15. A computer-readable medium having computer-executable instructions for performing the method of claim 1.

16. In a computing environment, a method comprising:
constructing a request for taxonomy data, the request including data corresponding to an origin node within a taxonomy and data indicating that the request seeks data from one or more nodes that have a specified genealogical relationship with the origin node;
communicating the request to a server; and
receiving a response including data corresponding to at least one node that has the specified genealogical relationship with the origin node.

17. The method of claim 16 wherein a specified genealogical relationship with the origin node comprises an ancestor relationship.

18. The method of claim 17 further comprising, specifying in the request a number indicating a number of generations of ancestors for which corresponding data is sought.

19. The method of claim 16 wherein a specified genealogical relationship with the origin node comprises a descendant relationship.

20. The method of claim 19 further comprising, specifying in the request a number indicating a number of generations of descendants for which corresponding data is sought.

21. The method of claim 16 wherein a specified genealogical relationship with the origin node comprises a sibling relationship.

22. The method of claim 16 wherein a specified genealogical relationship with the origin node comprises a family relationship.

23. The method of claim 16 wherein constructing a request for taxonomy data comprises constructing an XML message.

24. The method of claim 23 wherein communicating the request to a server comprises sending the XML message to a UDDI server.

25. The method of claim 16 wherein communicating the request to a server comprises sending a message seeking device information.

26. A computer-readable medium having computer-executable instructions for performing the method of claim 16.

27. In a computing environment, a system comprising:
a client, the client including an application program that sends a request for taxonomy-related data, the request including data corresponding to an origin node in a taxonomy and information indicating at least one genealogical relationship with the origin node;
expansion logic that receives the request from the client and converts the request to seek taxonomy-related data from each node having a genealogical relationship with the origin node that matches a genealogical relationship indicated in the request; and
a database that maintains taxonomy data, the database coupled to the expansion logic receive at least one taxonomy-related request corresponding to the client request, and in response to each request, to locate data including at least some of the taxonomy-related data requested by the client.

28. The system of claim 27 wherein the information indicating at least one genealogical relationship specifies that taxonomy-related data is being sought from at least one ancestor node.

29. The system of claim 27 wherein the information indicating at least one genealogical relationship specifies that taxonomy-related data is being sought from at least one descendant node.

30. The system of claim 27 wherein the information indicating at least one genealogical relationship specifies that taxonomy-related data is being sought from at least one sibling node.

31. The system of claim 27 wherein the taxonomy-related request from the client comprises an XML message.

32. The system of claim 27 wherein the database is coupled to the expansion logic via a server.

33. The system of claim 27 wherein the database is accessed through a server, and wherein the expansion logic is incorporated in a middle tier between the client and the server.

34. The system of claim 27 wherein the client provides the request to the server by calling an application programming interface, the application programming interface formatting the request as a message for communicating with the server.

35. A computer-readable medium having stored thereon a data structure, comprising:
a first field having data corresponding to an origin node in a taxonomy;
a second field having data indicating a genealogical relationship with the origin node; and
wherein the data structure is interpreted to seek data from at least one node of the taxonomy that matches the genealogical relationship indicated in the second field.

36. The data structure of claim 35 wherein the second field comprises data indicating that the genealogical relationship corresponds to at least one generation of an ancestor node of the origin node.

37. The data structure of claim 35 wherein the second field comprises data indicating that the genealogical relationship corresponds to at least one generation of descendant nodes of the origin.

38. The data structure of claim 35 wherein the second field comprises data indicating that the genealogical relationship corresponds to at least one sibling node of the origin.

39. The data structure of claim 35 further comprising a third field having data indicating that the data structure, when interpreted, is requesting expanded information relative to the origin node.
